(19) United States
(12) Patent Application Publication
(10) Pub. No.: US 2024/0372141 A1
(43) Pub. Date: Nov. 7, 2024

(54) ELECTROLYTE FOR SECONDARY BATTERY AND SECONDARY BATTERY INCLUDING SAME

(71) Applicant: Microvast, Inc., Stafford, TX (US)

(72) Inventors: Yun Xu, Huzhou (CN); Bryan Yonemoto, Stafford, TX (US); Han Jiang, Huzhou (CN)

(21) Appl. No.: 18/143,090

(22) Filed: May 4, 2023

(51) Int. Cl. H01M 10/0567

(52) U.S. Cl. CPC H01M 10/0567; H01M 2300/0025

(57) ABSTRACT

The present invention provides an electrolyte for a secondary battery and a secondary battery including same. The electrolyte for a secondary battery comprises a solvent comprising a compound having a structure represented by Formula, wherein R is selected from H, F, CH₃ and CF₃; R′ and R″ are each independently selected from H, CH₃, CH₂CH₃, CF₃, CH₂CF₃ and CF₂CH₃; and wherein based on the total weight of the solvent, the amount of the compound represented by formula I ranges from 81 wt % to 99 wt %; or the amount of the compound represented by formula I ranges from 90 wt % to 99 wt % By using the electrolyte for a secondary battery and the secondary battery including same of the present invention, the formed SEI film is more stable thereby prevent the electrolyte further reduced by anode, and increased battery life and cycle stability could be achieved.

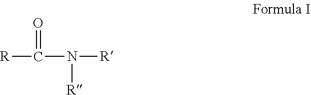

### TECHNICAL FIELD

The present invention relates to the field of electrochemical cells, and in particular, to an electrolyte for a secondary battery and a secondary battery including same.

### BACKGROUND

Lithium ion secondary batteries in the prior art generally have a graphite anode, and graphite anode only have a discharge capacity of 372 mAh/g, this is not enough to satisfy the demand for long range electric vehicles. One alternative to the graphite is to instead use metal plating/stripping. For example, lithium metal can deliver an ultrahigh specific capacity of 3860 mAh/g. The volumetric energy density could easily reach as high as 1000 Wh/L with ultrathin lithium metal battery. While the electrolyte for lithium ion batteries are well-developed carbonate based electrolyte, electrolyte for lithium metal batteries or anode free batteries is still an emerging field.

State of art carbonate based electrolytes are unstable to lithium metal and, in use, tend to cause lithium dendrite formation in the anode region after multiple charge-discharge cycles, thereby accelerating electrolyte consumption. The challenge of developing a new type of electrolyte is how to make lithium metal or any other metal more stable during the charge-discharge cycle of the battery, and to make the formed SEI film stably remain on the electrode surface and prevent further decomposition of the SEI film. The method for solving the above-mentioned technical problems in the prior art usually lies in the use of a highly concentrated or locally concentrated electrolyte. This highly concentrated electrolyte increases cost when compared to conventional carbonate based electrolytes in lithium ion batteries, or a fluorinated co-solvent is used to dilute the electrolyte. These high concentrated electrolyte or localized high concentrated electrolyte are often ether based electrolyte, they suffer from a problem of high viscosity, high cost. In addition, ether based electrolyte typically has lower thermal stability and are often flammable.

Batteries using amide-based solvents have been developed in the prior art. For example, U.S. Pat. No. 4,166,888 A discloses a novel electric current-producing cell, which comprising (a) an alkali metal anode; (b) a catalyst containing of fluorinate carbon and (c) a electrolyte while includes an alkali metal salt and a mixed solvent system containing a substituted amide solvent and a cyclic carbonate copolymer. However, the use of cosolvents is still unavoidable in this patent, and the electrical properties of the resultant batteries are not desirable.

Therefore, there is a need to develop an alternative electrolyte in which lithium metal or any other metal is more stable, and the electrochemical performance of the battery is improved.

### SUMMARY

The main purpose of the present invention is to provide an electrolyte for a secondary battery and a secondary battery including same, to solve the problem of instability and low electrochemical performance of lithium metal or other metals in electrolytes in the prior art.

In order to achieve the purpose above, according to one aspect of the present invention, provided is an electrolyte for a secondary battery, comprising: a solvent composed of a compound having a structure represented by Formula I:

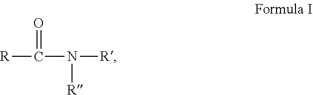

wherein R is selected from H, F, CH₃ and CF₃; R′ and R″ are each independently selected from H, CH₃, CH₂CH₃, CF₃, CH₂CF₃ and CF₂CH₃; and wherein based on the total weight of the solvent, the amount of the compound represented by formula I ranges from 81 wt % to 99 wt %; or, the amount of the compound represented by formula I ranges from 90 wt % to 99 wt %.

In the electrolyte for a secondary battery, the compound represented by formula I comprises one or any combination of the following: acetamide, N-methylformamide, N-ethylformamide, N,N-dimethylformamide, N, N-dimethylacetamide, N, N-diethylformamide, N,N-diethylacetamide, N-methyl-N-ethylformamide, N-methyl-N-ethylacetamide, 2,2,2-trifluoroacetamide, N-methyl-fluoroformamide, N-ethyl-fluoroformamide, N, N-dimethyl-fluorocarboxamide, N, N-diethyl-fluorocarboxamide, N-methyl-N-ethyl-fluorocarboxamide, N-methyl-2,2,2-trifluoroacetamide, N-ethyl-2,2,2-trifluoroacetamide, N,N-bis(trifluoromethyl)formamide, N, N-bis(trifluoroethyl)formamide, N,N-bis(difluoroethyl)formamide, N, N-bis(trifluoromethyl)acetamide, N, N-bis(trifluoroethyl)acetamide, N, N-bis(difluoroethyl)acetamide.

In the electrolyte for a secondary battery, the compound represented by formula I comprises any one or any combination of the following: N, N-dimethylformamide, 2,2,2-trifluoroacetamide, N-methyl-N-ethylformamide and N-methylformamide.

In the electrolyte for a secondary battery, the electrolyte further comprises a salt, based on the total volume of the electrolyte, the concentration of the salt ranges from 0.5 mol/L to 7 mol/L; or, the concentration of the salt ranges from 1 mol/L to 4 mol/L.

In the electrolyte for a secondary battery, the salt comprises a cationic moiety and an anionic moiety, the cationic moiety comprises Li⁺, Na⁺, K⁺, Mg²⁺, Ca²⁺ or Zn²⁺, and the anionic moiety comprises PF₆⁻, BF₄⁻, ClO₄⁻, NO₃⁻, AsF₆⁻, bis(fluorosulfonyl)imide (FSI-), (trifluoromethyl)imidazolide (TDI-) or bis(trifluoromethanesulfonimide) (TFSI-).

In the electrolyte for a secondary battery, the salt comprises LiFSI and/or LiNO₃.

In the electrolyte for a secondary battery, the electrolyte further comprises an electrolyte additive.

In the electrolyte for a secondary battery, based on the total weight of the solvent, the amount of the electrolyte additive ranges from 1 wt % to 19 wt %; or the amount of the electrolyte additive ranges from 5 wt % to 15 wt %.

In the electrolyte for a secondary battery, the electrolyte additive comprises fluoroethylene carbonate or ethylene carbonate.

According to another aspect of the present invention, provided is a secondary battery, comprising: the electrolyte for a secondary battery according to present application.

In the secondary battery, the secondary battery further comprises a cathode, the cathode material of the cathode is oxide based.

In the secondary battery, the cathode material of the cathode is selected from the group consist of: LiFePO₄, LiMn₂O₄, LiNi_{1/4}M_{n3/4}, LiFexMn₍₁₋ₓ₎PO₄, LiCoO₂, LiNiO₂ and LiNiₓCo_{y}Mn_{z}O₂ (x+y+z=1, 0<x<1, 0<y<1, and 0<z<1).

In the secondary battery, the secondary battery further comprises a separator, and the separator is a polypropylene (PP) separator, a polyethylene (PE) separator or an aramid separator.

In the secondary battery, the secondary battery further comprises an anode, and the anode is an alkaline metal, or the anode is lithium metal.

In the secondary battery, the secondary battery is anode-free battery, the anode is composed of anode current collector and does not comprise a negative active materials.

In the secondary battery, the anode current collector is metal sheet.

In the secondary battery, the metal sheet comprise copper sheet, or aluminum sheet.

In the secondary battery, when charging and discharging at a rate up to 2 C at room temperature, the secondary battery is cycled in the range from 0 V to 5 V; or the secondary battery is cycled in the range from 1.5 V to 4.5 V.

### Advantageous Effects of Invention

By using the electrolyte for a secondary battery and the secondary battery including same of the present invention, the formed SEI film is more stable thereby prevent the electrolyte further reduced by anode, and increased battery life and cycle stability could be achieved.

The present invention achieves the following effect:
1. Avoiding the use of expensive and toxic fluorinated co-solvents while the batteries show excellent stability against alkaline metal especially lithium and high voltage.
2. Improving ion mobility compared to high concentration electrolytes for metal anodes, the amide electrolyte shows an ionic conductivity higher than 8.8 ms/cm compared to about 4.3 ms/cm for the ether based localized high concentration electrolyte.
3. Improving safety of batteries because the amide-based electrolyte solvent of present invention has high flash point which is highly non-flammable compared to the 0° C. of DME or 18° C. of the carbonate based electrolyte.
4. The electrochemical cell of present invention can be oxide cathode based, electrolyte with the amide-based electrolyte solvent of present invention is stable with the high voltage cathode NCM up to 4.3V.

### BRIEF DESCRIPTION OF THE DRAWINGS

The accompanying drawings, which form a part of the present application, are used to provide a further understanding of the present invention. The schematic embodiments of the present invention and the description thereof are used to explain the present invention, and do not form improper limits to the present invention. In the drawings:

FIG. 1 shows results of a polarization experiment of Li/Li symmetric cell prepared using the electrolytes of Example 1 and Comparative Example 1.

FIG. 2 shows results of the Coulombic efficiency test of Li//Cu asymmetric cell prepared using the electrolytes of Examples 1-3 and Comparative Example 1.

FIG. 3 shows results of the Coulombic efficiency test of Li//Cu asymmetric cell prepared using the electrolyte of Example 6.

FIG. 4 shows results of linear sweep voltammetry measurement of stainless steel//Li cell prepared using the electrolyte of Example 1.

FIG. 5 shows results of the cycle performance test of coin cell prepared using the electrolyte of Example 1.

### DETAILED DESCRIPTION OF THE EMBODIMENTS

It is important to note that the embodiments of the present disclosure and the characteristics in the embodiments can be combined under the condition of no conflicts. The present disclosure will be described below with reference to the drawings and embodiments in detail.

As explained in the background art, in the prior art, a carbonate based solvent is generally used in an electrolyte for a secondary battery. However, the use of a carbonate based solvent would disadvantageously lead to poor stability of lithium metal or any other metal in charge and discharge cycles of the battery, and would deteriorate electric performance of the battery. Therefore, there is still a need to develop a novel solvent material for an electrolyte for a secondary battery. In view of the problems in the related art, according to an exemplary embodiment of the present invention, an electrolyte for a secondary battery is provided. The electrolyte comprises a salt; and a solvent composed of a compound having a structure represented by Formula I:

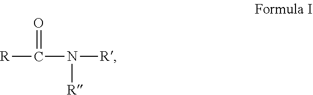

wherein R is selected from H, F, CH₃ and CF₃⁻; R′ and R″ are each independently selected from H, CH₃, CH₂CH₃, CF₃, CH₂CF₃ and CF₂CH₃; and based on the total weight of the solvent, the amount of the compound represented by formula I ranges from 81 wt % to 99 wt %; or the amount of the compound represented by formula I ranges from 90 wt % to 99 wt %.

Different from carbonate solvents used in the prior art, a novel amide compound is used as the solvent in the electrolyte of the present invention. Such solvent is different from carbonate-based electrolytes or ether-based highly concentrated or locally concentrated electrolytes widely used in the prior art. The amide-based electrolyte of the present invention is not limited to intercalation chemistry batteries, and can also be used in Li—S batteries, Li-air battery, etc. Furthermore, the electrolyte of the present invention is not limited to a lithium ion battery, and can also be used as an electrolyte for sodium ion batteries, potassium ion batteries, magnesium ion batteries, or zinc ion batteries.

According to the theory in the prior art, lithium metal in a lithium ion battery is highly likely to undergo a side reaction with a carbonate electrolyte in a charge and discharge cycle to cause continuous SEI growth and dendrite formation. In the prior art, high concentrated electrolyte or localized high concentrated electrolyte is generally adopted so that free solvent molecules are minimized and less reactive to lithium metal. However the use of high concentrations introduces challenges like poor ionic conductivity, high viscosity and high cost. Unlike methods in the related art, an amide-based substance which is used as an electrolyte additive is directly used in the present invention as a solvent of the electrolyte. Unlike the ester group or ether group which tend to be reduced to Li₂O or Li₂CO₃, amide group is reduced to LigN which is more ionic conductive. Thus the SEI formed in amide electrolyte is more beneficial for preventing dendrite formation. The electrolyte of the present invention provides better stability, thereby avoiding generation of side reactions and dendrite formation, and increasing cycle stability and lifespan of the secondary battery. A battery prepared from the electrolyte comprising an amide solvent of the present invention exhibits an ionic conductivity of at least 8.85 ms/cm, while a battery comprising a metal anode in a highly concentrated electrolyte (ether based electrolyte) in the prior art exhibits an ionic conductivity of only 4.35 ms/cm.

In the prior art, in order to further achieve a high concentration or a locally high concentration of an electrolyte, flourinated co-solvents are often used as diluent, such as tris(2,2,2-trifluoroethyl)orthoformate (TFEO), bis(2,2,2-trifluoroethyl)ether (BTFE) and 1, 1,2,2-tetrafluoroethyl-2,2,3,3-tetrafluoropropylether (TTE). These co-solvents, however, often expensive and toxic. In the use of batteries and the subsequent waste battery treatment, these co-solvents adversely affect the health of the human body or the environment, and cause irreversible adverse consequences. However, in the present invention, as the amide-based electrolyte solvent represented by formula I is used, it is not necessary to additionally add other co-solvents, thereby avoiding the adverse effect of toxic substances.

In addition, the amide-based electrolyte solvent of the present invention also exhibits excellent stability. Taking N,N-dimethylacetamide as an example, its flash point is 66° C., whereas the flash point of 1,2-Dimethoxyethane (DME) used in the prior art is 0° C., and the flash point of dimethyl carbonate is 18° C. Therefore, compared with flammable carbonate-based electrolytes and ether-based electrolytes used in the prior art, the electrolyte based on an amide-based solvent of the present invention exhibits excellent non-flammability.

In various embodiments of the present invention, the amount of the amide-based solvent represented by formula I of the present invention is in the range from 81 wt % to 99 wt % based on the total weight of the solvent. In alternative embodiments, the amount of the amide-based solvent represented by formula I of the present invention may be in a range of 81 wt % to 99 wt %, 82 wt % to 99 wt %, 83 wt % to 99 wt %, 84 wt % to 99 wt %, 85 wt % to 99 wt %, 90 wt % to 99 wt %, 95 wt % to 99 wt %, 96 wt % to 99 wt %, 97 wt % to 99 wt %, 98 wt % to 99 wt %, 81 wt % to 98 wt %, 81 wt % to 97 wt %, 81 wt % to 96 wt %, 81 wt % to 95 wt %, 81 wt % to 94 wt %, 81 wt % to 93 wt %, 81 wt % to 92 wt %, 81 wt % to 91 wt %, or 81 wt % to 90 wt %, based on the total weight of the solvent.

In some embodiments of the present invention, the amide-based electrolyte solvent represented by formula I comprises one or any combination of the following: formamide, acetamide, N-methylformamide, N-methylacetamide, N-ethylformamide, N-ethylacetamide,

N-dimethylformamide, N,N-dimethylacetamide, N, N-diethylformamide, N,N-diethylacetamide, N-methyl-N-ethylformamide, N-methyl-N-ethylacetamide and mono-, di-or trifluoro substituted products of the foregoing. The fluorine substitutions of the aforementioned amides can include 2,2,2-trifluoroacetamide, N-methyl-fluoroformamide, N-ethyl-fluoroformamide,

N, N-diethyl-fluorocarboxamide, N,N-dimethyl-fluorocarboxamide, N-methyl-N-ethyl-fluorocarboxamide, N-methyl-2,2,2-trifluoroacetamide, N-ethyl-2,2,2-trifluoroacetamide, N,N-bis(trifluoromethyl)formamide, N,N-bis(trifluoroethyl)formamide, N,N-bis(difluoroethyl)formamide, N,N-bis(trifluoromethyl)acetamide, N,N-bis(trifluoroethyl)acetamide, N,N-bis(difluoroethyl) acetamide and the like. Or, the amide-based electrolyte solvent of the present invention comprises N, N-dimethylformamide, 2,2,2-trifluoroacetamide, N-methyl-N-ethylformamide and N-methylformamide.

According to some embodiments of the present invention, the concentration of the salt comprised in the electrolyte ranges from 0.5 mol/L to 7.0 mol/L based on the total volume of the electrolyte; or, the concentration of the salt ranges from 1 mol/L to 4 mol/L. In the electrolyte of the present invention, the concentration of the salt is based on the total volume of the electrolyte, which comprises the electrolyte solution and any possible additives. As the electrolyte solvent of the present invention uses an amide-based solvent, it has better solubility for ionic electrolyte salts. In the case of use of conventional electrolyte salts, their concentration may reach 5 mol/L.

In various embodiments of the present invention, the concentration of the salt comprised in the electrolyte may be in a range of 0.5 mol/L to 7mol/L, 1 mol/L to 4.5 mol/L, 1.5 mol/L to 4 mol/L, 2 mol/L to 3.5 mol/L, 2.5 mol/L to 3 mol/L, 0.5 mol/L to 4.5 mol/L, 0.5 mol/L to 4 mol/L, 0.5 mol/L to 3.5 mol/L, 0.5 mol/L to 3 mol/L, 0.5 mol/L to 2.5 mol/L, 1 mol/L to 5 mol/L, 1 mol/L to 4 mol/L, 1.5 mol/L to 5 mol/L, 2 mol/L to 5 mol/L, 2.5 mol/L to 5 mol/L, 3 mol/L to 5 mol/L or 4 mol/L to 5 mol/L, based on the total volume of the electrolyte.

According to another embodiment of the present invention, the salt of the present invention can be an alkali salt, an alkaline earth salt or any substance that can be used as an electrolyte salt. In another embodiment, the salt used in the electrolyte of the present invention may comprises a cationic moiety and an anionic moiety, wherein the cationic moiety comprises Li⁺, Na⁺, K⁺, Mg²⁺, Ca²⁺ or Zn²⁺, and the anionic moiety comprises PF₆⁻, BF₄⁻, ClO₄⁻, NO₃⁻, AsF₆⁻, bis(fluorosulfonyl)imide (FSI-), (trifluoromethyl)imidazolide (TDI-) or bis(trifluoromethanesulfonimide) (TFSI-). As the present invention uses an amide-based solvent, the electrolyte salt composed of the described cationic moiety and anionic moiety can be better dissolved in the electrolyte. In an embodiment, the electrolyte salt is selected from LiFSI and/or LiNO₃. LiFSI and LiNO₃ are both excellent electrolyte salts, and are both recognized in the secondary battery field as having good transmission efficiency. However, the solubility of the LiNO₃, is very low in ether electrolytes and carbonate electrolytes, and for example, in carbonate electrolytes, the concentration of LiNO₃ is only 0.03 mol/L. However, in the prior art, LiNO₃ is often added as additive to form stable SEI with Li₃N as component. Without being bound by theory, the inventors of the present invention have surprisingly found that in the case of using the amide-based electrolyte solvent of the present invention, the concentration of LiNO₃ are significantly increased. As described in the foregoing, in the present invention, the total concentration of the electrolyte salt may be up to 7 mol/L, thereby greatly improving the ion transmission efficiency, and further improving the electrochemical performance of the battery.

In an additional embodiment of the present invention, the electrolyte may further contain an electrolyte additive. In order to improve battery characteristics, the electrolyte may contain a known additive. The electrolyte additive used in the present invention is generally used to form a passivation layer (namely, solid electrolyte interface, or SEI for short) covering the surface of an electrode material during the first charging and discharging of a battery. The SEI has characteristics of a solid electrolyte, is an electronic insulator, but is a good conductor of cations such as lithium ions. SEI is ionic conductive. The stability of the SEI is crucial to the cycle performance of the battery. A stable SEI can significantly improve the performance of a battery; on the contrary, if the SEI is unstable, the SEI will grow continuously during charging and discharging, thereby increasing the polarization and internal resistance of the battery, and further deteriorating the cycle performance of the battery. The use of an electrolyte additive is a simple and efficient method for improving battery cycle stability. Currently, a common method is to add a small amount of an additive into an electrolyte. The electrolyte additive can react with an electrode material preferentially than a solvent, to generate a stable SEI on the surface of the negative electrode, thereby inhibiting the further reduction of solvent molecules. Electrolyte additives that can be used in the present invention include fluoroethylene carbonate (FEC), ethylene carbonate (EC), vinylene carbonate (VC) and the like.

In a particular embodiment, based on the total weight of the solvent, the amount of the electrolyte additive is in the range from 1 wt % to 19 wt %, in the range from 2 wt % to 18 wt %, in the range from 3 wt % to 17 wt %, in the range from 4 wt % to 16 wt %, in the range from 5 wt % to 15 wt %, in the range from 2 wt % to 19 wt %, in the range from 3 wt % to 19 wt %, in the range from 4 wt % to 19 wt %, in the range from 5 wt % to 19 wt %, in the range from 6 wt % to 19 wt %, in the range from 7 wt % to 19 wt %, in the range from 8 wt % to 19 wt %, in the range from 9 wt % to 19 wt %, in the range from 10 wt % to 19 wt %, in the range from 1 wt % to 18 wt %, in the range from 1 wt % to 17 wt %, in the range from 1 wt % to 16 wt %, in the range from 1 wt % to 15 wt %, in the range from 1 wt % to 14 wt %, in the range from 1 wt % to 13 wt %, in the range from 1 wt % to 12 wt %, in the range from 1 wt % to 11 wt % or in the range from 1 wt % to 10 wt %. Or, the amount of the electrolyte additive is in the range from 5 wt % to 15 wt %.

In another typical embodiment of the present invention, there is provided a secondary battery comprising an anode; a cathode; separator; and the electrolyte for a secondary battery according present invention. The electrolyte comprises the amide-based solvent of formula I as described before and a salt. As the electrolyte of the present invention is comprised, the secondary battery of the present invention can exhibit excellent ionic conductivity, increased battery life and cycle stability. or, the secondary battery of the present invention is a lithium ion battery, an anode free battery, a sodium ion battery, a potassium ion battery, a magnesium ion battery or a zinc ion battery.

In an embodiment, the cathode material of the cathode used in the secondary battery of the present invention is oxide based. The cathode of the present invention comprises a cathode current collector and a cathode active material. A cathode active material layer is formed on either or both surfaces of the cathode current collector. A metal foil such as aluminum foil is used as the cathode current collector.

The cathode active material contains one or two or more of cathode materials capable of intercalate or deintercalate ions such as lithium ions, and may contain, if necessary, another material such as a binder and/or a conductive agent.

More, the cathode material is a lithium-containing compound. Examples of such lithium-containing compound may include a lithium-transition metal composite oxide, a lithium-transition metal phosphate compound and the like. The lithium-transition metal composite oxide is an oxide containing lithium and one or two or more transition metal elements as constituent elements, and the lithium-transition metal phosphate compound is a phosphate compound containing lithium and one or two or more transition metal elements as constituent elements. Among them, the transition metal element is favorably any one or two or more of Co, Ni, Mn, Fe and the like.

Examples of the lithium-transition metal composite oxide include, for example, LiCoO₂, LiNiO₂ and the like. Examples of the lithium-transition metal phosphate compound include, for example, LiFePO₄, LiFe₁₋ᵤMnᵤPO₄ (0<u<1) and the like.

In some embodiments of the present application, the cathode material may be a ternary cathode material, such as lithium nickel cobalt aluminum oxide (NCA) or lithium nickel cobalt manganese oxide (NCM). A specific example may be LiₓNi_{y}Co_{z}Al_{1-y-z}O₂ (1≤x≤1.2, 0.5≤y≤1, and 0<z<0.5) or LiNiₓCo_{y}Mn_{z}O₂ (x+y+z=1, 0<x<1, 0<y<1, and 0<z<1). Specific examples of the cathode material may include, but are not limited to, LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂ and Li_{1.15}(Mn_{0.65}Ni_{0.22}Co_{0.13})O₂, LiFePO₄, LiMnPO₄, LiFe_{0.5}Mn_{0.5}PO₄ and LiFe_{0.3}Mn_{0.7}PO₄.

Alternatively, the cathode material of the present invention may be selected from the group consisting of LiFePO₄, LiMn₂O₄, LiNi_{1/4}Mn_{3/4}O₄, LiFeₓMn₍₁₋ₓ₎PO₄, LiCoO₂, LiNiO₂, LiNiₓCo_{y}Mn_{z}O₂ (x+y+z=1, 0<x<1, 0<y<1, and 0<z<1).

The separator of the present invention is used to separate the anode and cathode in a battery and to allow passage of ions while preventing electrical short circuiting due to contact between the two electrodes. The separator is, for example, a porous film formed of a polymer, or the like, and may be a laminated film in which two or more porous films are laminated. Examples of the polymers include polytetrafluoroethylene, polypropylene, polyethylene, cellulose and the like, for example. Or, the separator of the present invention is a polypropylene (PP) separator, a polyethylene (PE) separator or aramid separator.

When charging and discharging at a rate of 2 C at a temperature range from 20° C. to 30° C., the secondary battery is cycled in the range from 0V to 5V; or, the secondary battery is cycled in the range from 2.7V to 4.4V.

The electrolytic solution of the invention can be used in various types of secondary batteries which have been currently developed, such as lithium ion batteries, anode free batteries, lithium metal batteries, sodium metal batteries, sodium ion batteries, potassium metal batteries, potassium ion batteries, magnesium metal batteries, magnesium ion batteries, zinc ion batteries, zinc metal batteries, and the like. In particular, the electrolyte solution of the present invention can be applied to an anode-free battery. The “anode-free battery” in the present invention means a lithium ion battery, which is different from a traditional lithium ion battery. The anode-free battery does not use a traditional anode which made of graphite or other carbon-based materials. In an anode-free battery, the anode of the battery only comprises an anode current collector, but does not comprise a negative active materials. After the first cycle of the anode-free battery, the material in the electrolyte, such as metallic lithium, will plate directly onto the anode current collector, thereby forming a final anode structure. In the case of using the electrolyte of the invention, the anode-free battery will make it possible to electroplate more metallic lithium onto the anode current collector in the first cycle, thereby increasing the energy density and achieving a longer cycle life and improved safety.

### Examples

In a glove box, electrolyte salt, electrolyte solvent and electrolyte additive are mixed to prepare the electrolyte. The types and amounts of the solvent, the salt and the electrolyte additive used in the examples are summarized in Table 1. All the electrolytes of examples and comparative examples were prepared based on a total weight of 10 g for the solvent. Concentration is in unit of M (mol/L). Concentration of salts of examples and comparative examples were based on the total volume of the electrolyte.

TABLE 1

| | Electrolyte | | | | | |
|---|---|---|---|---|---|---|
| | | | | Amount of | | |
| | | Concentration | | solvent | Type of | Amount of |
| Examples | Type of salts | of salts | Type of solvent | (wt %) | additive | additive |
| 1 | LiFSi/LiNO₃ | 2M/1M | N,N-dimethylacetamide | 90% | FEC | 10% |
| 2 | LiFSi/LiNO₃ | 3M/1M | N,N-dimethylacetamide | 90% | FEC | 10% |
| 3 | LiFSi/LiNO₃ | 1M/1M | N,N-dimethylacetamide | 90% | FEC | 10% |
| 4 | LiFSi/LiNO₃ | 2M/1M | N,N-dimethylacetamide | 100% | FEC | 0 |
| 5 | LiFSi/LiNO₃ | 2M/1M | N,N-dimethylacetamide | 85% | FEC | 15% |
| 6 | LiFSi/LiNO₃ | 2M/1M | N,N-dimethylacetamide | 90% | FEC | 10% |
| 7 | LiFSi | 4M | N,N-dimethylacetamide | 90% | FEC | 10% |
| 8 | LiFSi/LiNO₃ | 2M/0.5M | N,N-dimethylacetamide | 90% | FEC | 10% |
| 9 | LiFSi/LiNO₃ | 2M/1M | 2,2,2-Trifluoroacetamide | 90% | FEC | 10% |
| 10 | LiFSi/LiNO₃ | 2M/1M | N-methyl-N-ethylformamide | 90% | FEC | 10% |
| 11 | LiFSi/LiNO₃ | 2M/1M | N-methylformamide | 90% | FEC | 10% |
| 12 | LiFSi/LiNO₃ | 2M/1M | N,N-dimethylacetamide | 90% | VC | 10% |
| 13 | LiFSi/LiNO₃ | 2M/1M | N,N-dimethylacetamide | 95% | VC | 5% |
| 14 | LiFSi/LiNO₃ | 2M/1M | N,N-dimethylacetamide | 80% | VC | 20% |

### Comparative Example 1

Ethylene carbonate and dimethyl carbonate were mixed in a volume ratio of 1:1, and LiPF₆ was added thereto at a concentration of 1 mol/L (based on the total volume of the electrolyte) to prepare an electrolyte.

### Comparative Example 2

1,2-Dimethoxyethane and 1,1,2,2-tetrafluoroethyl-2,2,3,3-tetrafluoropropyl ether were mixed at a volume ratio of 1:2.5, and then LiFSi was added thereto at a concentration of 1.5 mol/L (based on the total volume of the electrolyte) to prepare an electrolyte.

### Electrical Performance Test

### Ionic Conductivity Test

The electrolytes prepared in Example 1 and Comparative Example 2 were tested for ionic conductivity at 25° C. by a same ion conductivity Meter (test temperature was set at about 25 degrees Celsius). The test results show ionic conductivity of 8.8 ms/cm for Example 1 and 4.3 ms/cm for Comparative Example 2. It can be determined from the described experimental results that the electrolyte of the present invention containing an amide-based material as a solvent exhibits increased ionic conductivity. The ionic conductivity of the electrolyte of Example 1 achieved more than twice the ionic conductivity of locally concentrated ether-based electrolytes in the prior art.

### Polarization Test

Lithium metal was used on both electrodes of the battery, a polyethylene film was used as the separator of the battery, and the electrolytes of Example 1 and Comparative Example 1 are respectively used as the electrolytes of the battery of the examples, respectively, so as to prepare Li/Li symmetrical batteries or Li/Li symmetrical cell (button batteries or button cell). The prepared button batteries of Example 1 and Comparative Example 1 were charged and discharged at 25° C. with a constant current density of 0.5 mA/cm², wherein the cycle capacity was 0.5 mAh/cm².

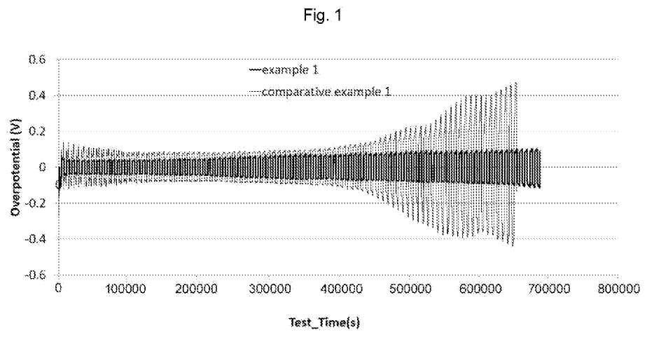

The test results are shown in FIG. 1. The battery interface stability using the electrolytes of Example 1 and Comparative Example 1 are compared in FIG. 1, wherein the results of Example 1 exhibit less over potential growth than Comparative Example 1. It can be determined from FIG. 1 that the battery of Example 1 only exhibits an overpotential growth of 0.1 V while Comparative Example 1 achieves surprisingly an overpotential growth of more than 0.4 V at a test time of 65,000 S.

### Coulombic Efficiency Test

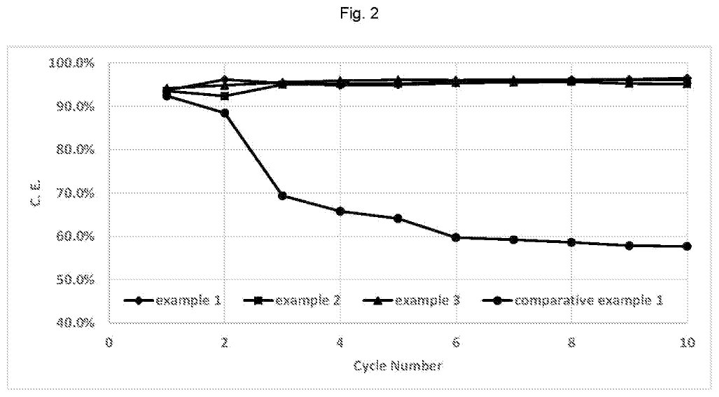

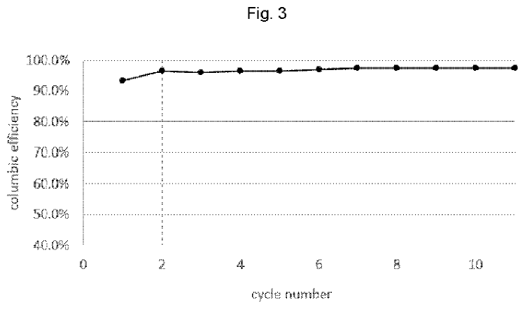

Li/Cu asymmetric batteries were respectively prepared by using lithium metal as the anode, copper as the cathode, a polyethylene film as the separator, and the electrolyte of Examples 1-3 and 5 and Comparative Example 1 as the electrolyte, and Coulombic efficiency was measured by electroplating and stripping lithium on the copper electrode. Lithium of 1 mAh was plated onto the Cu electrode and stripped to a voltage of 1V. The Coulombic efficiency was calculated by the stripping capacity/plating capacity. The test results are shown in FIGS. 2 and 3.

FIG. 2 shows the Coulombic efficiency of the Li//Cu asymmetric batteries of Examples 1-3 and Comparative Example 1, wherein the Coulombic efficiency of Comparative Example 1 begins to decrease at the second cycle, and reaches unacceptable 60% or less after 6 cycles. The Coulombic efficiency of each of Examples 1-3 is significantly better than that of other Examples and Comparative Examples, and maintains above 95% after 10 cycles.

FIG. 3 shows the Coulombic efficiency of Example 5. The Coulombic efficiency of Example 5 is the same as that of Examples 1-3 and maintains above 95% after 10 cycles.

### Linear Sweep Voltammetry

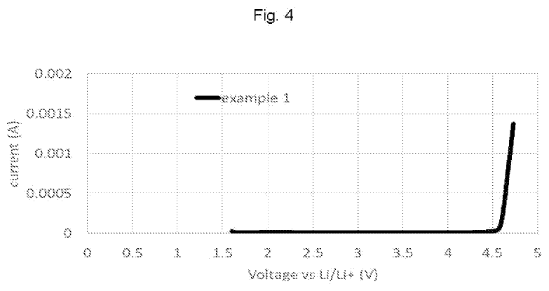

Stainless steel was used as the working electrode, a lithium chip was used as the anode, polyethylene was used as the separator of the battery, and 20 μL of the electrolyte of Example 1 was dropped on the separator to prepare a button cell. A sweep rate of 1 mV/s was applied to the prepared button cell to make a linear scanning voltammetry measurement of the battery. The experimental results are shown in FIG. 4.

FIG. 4 shows results of a linear sweep voltammetry measurement of the stainless steel/Li battery prepared in Example 1. As shown in FIG. 4, the battery exhibits stability in the voltage range from 1.5 V to 4.5 V. Thus the battery comprising an oxide-based cathode and the amide-based electrolyte solvent of the present invention may operate in a voltage range from at least 2.7V to 4.3V.

### Cycle Performance Test

Button cell preparation: 95 wt % of cathode powder (LiNi_{0.6}Co_{0.2}Mn_{0.2}O₂, 19 grams), 3 wt % of conductive carbon black (0.6 grams) and 2 wt % of a PVDF binder (0.4 grams) were mixed. The resulting mixture was mixed with 30 grams of N-methyl pyrrolidone (NMP) to form a slurry. The slurry was coated on aluminum foil to a desired thickness, and then dried under vacuum. The dried coated foil was compressed to a desired thickness (about 70 μm) and then punched to give the cathode electrode. The cathode electrode had a diameter of 15 mm and had a cathode active material loading amount of 28.6 mg/cm² and a density of 3.0 g/cm³. The separator was cut into 19 mm diameter pieces. A lithium sheet having a diameter of 15 mm was used as the anode. 20 μL of the electrolyte prepared in Example 1 was added dropwise to the separator prior to assembly. Thus, a coin cell was prepared.

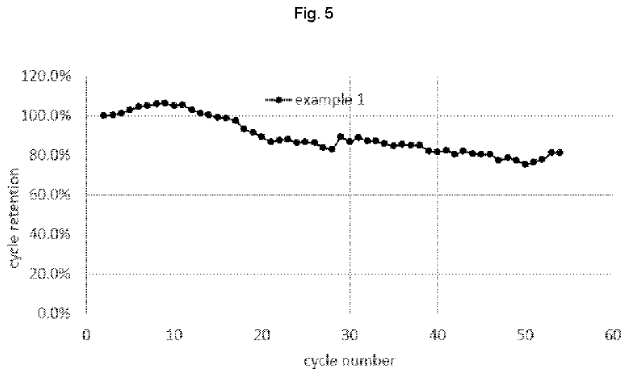

Charging and discharging cycles were performed in a voltage range from 2.7 V to 4.3 V at a C/3 rate to measure the cycle performance of the battery. The experimental results are shown in FIG. 5

Cycle performance data for the button cell with the electrolyte prepared as in Example 1 are shown in FIG. 5.

It can be determined from the described experiments that, in the case where the electrolyte of the present invention is used, the electrochemical performance of the battery is obviously improved. From the results of polarization test and Coulombic efficiency test, it can be determined that the electrolyte of the present invention still achieves excellent stability and high voltage performance without containing expensive and toxic fluorinated co-solvents.

The results of the linear sweep voltammetry test and cycle performance test show that the secondary battery of the present invention is still stable at a high voltage of up to 4.5 V in the case where the oxide-based cathode and the amide-based electrolyte solvent are used.

It can be determined from the results of FIG. 1 that the polarization overpotential of Comparative Example 1 increases faster than that of Example 1 which shows stable overpotential with cycling. This result is consistent with the Coulombic efficiency data as shown in FIG. 2 which shows that the amide-based electrolyte of the present invention has much higher and more stable Coulombic efficiency than the carbonate-based electrolyte. This is because the amide-based electrolyte of the present invention can form a more stable SEI than the carbonate-based electrolyte, thereby effectively preventing electrolyte been further reduced by lithium.

In FIG. 3, Example 5 also shows the effect of adding FEC. As the addition amount of FEC is 15% in Example 5 compared to the addition amount of 10% in Example 1, the Coulombic efficiency of Example 5 is maintained at almost the same level as that of Example 1. In FIG. 4, the oxidation stability of the battery is demonstrated by the LSV data, Example 1 does not show electrochemical activity until 4.5 V, indicating that the amide-based electrolyte of the present invention can operate in batteries having an operating potential of up to 4.5 V. In FIG. 5, the battery with NCM 622 as the cathode, electrolyte prepared in Example 1, and lithium as the anode exhibits a capacity retention close to 80% after 50 cycles, indicating that the amide-based electrolyte is also stable for both lithium and the cathode.

The description above is only the preferred embodiments of the present invention, and is not intended to limit the present invention. For those skilled in the art, the present invention may have various modifications and variations. Any modifications, equivalent replacements, improvements and the like made within the spirit and principle of the present invention shall belong to the scope of protection of the present invention.

1. An electrolyte for a secondary battery, comprising:
a solvent comprising a compound having a structure represented by Formula I: 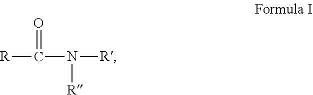
wherein R is selected from H, F, CH₃ and CF₃; R′ and R″ are each independently selected from H, CH₃, CH₂CH₃, CF₃, CH₂CF₃ and CF₂CH₃; and
wherein based on the total weight of the solvent, the amount of the compound represented by formula I ranges from 81 wt % to 99 wt %; or, the amount of the compound represented by formula I ranges from 90 wt % to 99 wt %.

2. The electrolyte for a secondary battery according to claim 1, wherein the compound represented by formula I comprises any one or any combination of the following:
acetamide, N-methylformamide, N-ethylformamide, N, N-dimethylformamide, N, N-dimethylacetamide, N, N-diethylformamide, N, N-diethylacetamide, N-methyl-N-ethylformamide, N-methyl-N-ethylacetamide, 2,2,2-trifluoroacetamide, N, N-dimethyl-fluorocarboxamide, N-methyl-N-ethyl-fluorocarboxamide, N-ethyl-2,2,2-trifluoroacetamide, N,N-bis(trifluoroethyl)formamide, N,N-bis(trifluoromethyl)acetamide, N, N-bis(difluoroethyl)formamide, N,N-bis(trifluoroethyl)acetamide, N,N-bis(difluoroethyl)acetamide. N-methyl-fluoroformamide, N-ethyl-fluoroformamide, N,N-diethyl-fluorocarboxamide, N-methyl-2,2,2-trifluoroacetamide, N,N-bis(trifluoromethyl)formamide,

3. The electrolyte for a secondary battery according to claim 2, wherein the compound represented by formula I comprises any one or any combination of the following: N,N-dimethylformamide, 2,2,2-trifluoroacetamide, N-methyl-N-ethylformamide and N-methylformamide.

4. The electrolyte for a secondary battery according to claim 1, wherein the electrolyte further comprises a salt, based on the total volume of the electrolyte, the concentration of the salt ranges from 0.5 mol/L to 7 mol/L; or, the concentration of the salt ranges from 1 mol/L to 4 mol/L.

5. The electrolyte for a secondary battery according to claim 1, wherein the salt comprises a cationic moiety and an anionic moiety, the cationic moiety comprises at least one from the group consist of Li⁺, Na⁺, K⁺, Mg²⁺, Ca²⁺ or Zn²⁺, and the anionic moiety comprises at least one from the group consist of PF₆⁻, BF₄⁻, ClO₄⁻, NO₃⁻, AsF₆⁻, bis (fluorosulfonyl) imide (FSI-), (trifluoromethyl) imidazolide (TDI-) or bis (trifluoromethanesulfonimide) (TFSI-).

6. The electrolyte for a secondary battery according to claim 5, wherein the salt comprises LiFSI and/or LiNO₃.

7. The electrolyte for a secondary battery according to claim 1, wherein the electrolyte further comprises an electrolyte additive.

8. The electrolyte for a secondary battery according to claim 7, wherein based on the total weight of the solvent, the amount of the electrolyte additive ranges from 1 wt % to 19 wt %; or the amount of the electrolyte additive ranges from 5 wt % to 15 wt %.

9. The electrolyte for a secondary battery according to claim 7, wherein the electrolyte additive comprises fluoroethylene carbonate and/or ethylene carbonate.

10. A secondary battery, comprising:
the electrolyte for a secondary battery according to claim 1.

11. The secondary battery according to claim 10, wherein the secondary battery further comprises a cathode, the cathode material of the cathode is oxide based.

12. The secondary battery according to claim 11, wherein the cathode material of the cathode is selected from the group consist of:
LiFePO₄, LiMn₂O₄, LiNi_{1/4}M_{3/4}O₄, LiFexMn₍₁₋ₓ₎PO₄, LiCoO₂, and LiNiₓCo_{y}Mn_{z}O₂ (x+y+z=1, 0<x<1, 0<y<1, and 0<z<1).

13. The secondary battery according to claim 10, wherein the secondary battery further comprises a separator, and the separator is a polypropylene (PP) separator, a polyethylene (PE) separator or an aramid separator.

14. The secondary battery according to claim 10, wherein the secondary battery further comprises an anode, and the anode is an alkaline metal, or the anode is lithium metal.

15. The secondary battery according to claim 10, wherein the secondary battery is anode-free battery, the anode is composed of anode current collector and does not comprise a negative active materials.

16. The secondary battery according to claim 15, wherein the anode current collector is metal sheet.

17. The secondary battery according to claim 16, wherein the metal sheet comprise copper sheet, or aluminum sheet.

18. The secondary battery according to claim 10, wherein when charging and discharging at a rate up to 2 C at room temperature, the secondary battery is cycled in the range from 0 V to 5 V; or the secondary battery is cycled in the range from 1.5 V to 4.5 V.
